(19) United States
(12) Patent Application Publication
(10) Pub. No.: US 2008/0072670 A1
(43) Pub. Date: Mar. 27, 2008

(54) Sensor for Motor Vehicles

(76) Inventors: Thomas Brandmeier, Wenzenbach (DE); Markus Christoph, Regensburg (DE); Christian Plankl, Burgweinting (DE); Christian Wieand, Grunthal (DE)

Correspondence Address: LERNER GREENBERG STEMER LLP, P O BOX 2480, HOLLYWOOD, FL, 33022-2480, US

(21) Appl. No.: 11/632,507

(22) PCT Filed: Jul. 14, 2005
(86) PCT No.: PCT/EP05/53389

§ 371 Date: Jan. 16, 2007

(30) Foreign Application Priority Data
Jul. 15, 2004 (DE) 10 2004 034 290.3

(51) Int. Cl. G01P 1/02

(52) U.S. Cl. 73/493

(57) ABSTRACT

An electrical device, especially a sensor for a motor vehicle, is adapted to be fastened on a mounting surface. The device includes a housing and a support plate. The support plate is rigidly linked with the housing through at least one connecting element. The support plate carries at least one electronic component that reacts to structure-borne noise and that is mounted in the immediate vicinity of the connecting element.

The present invention relates to an electrical device, especially a sensor for a motor vehicle, which is designed to be fastened on a mounting surface.

Sensors that react to pressure or acceleration have been used in the great majority of cases to date for the purpose of detecting a collision in order to drive and trigger a passenger protection system in a motor vehicle such as an airbag or other passenger protection system. It is intended to make greater use of sensors that operate on the basis of structure-borne noise signals to drive and trigger a passenger protection system in future. The advantage of a sensor that reacts to structure-borne noise as compared with a sensor that detects acceleration or pressure resides in the possibility furnished by the former of obtaining more specific information about the collision, for example by evaluating the structure-borne noise spectrum captured.

The structure-borne noise sensor must be connected to the car body of the motor vehicle as rigidly as possible if a structure-borne noise signal is to be transmitted reliably in the event of a motor vehicle impact in a car body component. The structure-borne noise sensor, which is realized as a surface mount technology (SMT) component, is arranged in a housing, which is advantageously attached to a car body component in the engine compartment.

DE 197 38 803 A1 describes an exemplary housing for a sensor. The housing it discloses comprises a plastic housing produced by injection molding having mounting flanges molded onto sides facing away from each other. Each mounting flange exhibits an opening, extending at right-angles to the mounting surface, to permit the passage of a screw bolt. The openings are situated within bushes that pass through the mounting flanges. The bushes consist of metal and are injection molded around their exterior with a housing material such that there is a form fit between the bushes and the housing. The bushes end flush with the upper surface of the mounting flange but protrude a small distance beyond the lower surface of the mounting flange. The housing is fastened by placing the bushes over screw bolts that are welded to the mounting surface and about which the nuts are rotated with the flange pressed against the surface in order to secure the housing to the mounting surface. The flange of the nuts presses against the exposed bearing face of the bushes, as a result of which the tension force of the screwed connection is transferred to the component by the bushes alone.

DE 197 38 803 does not disclose the types of sensor for which the housing is intended to be used. This arrangement does not ensure the undistorted transmission of structure-borne noise signals that propagate through the car body in the event of a motor vehicle impact to a structure-borne noise sensor arranged in the interior of the housing, however, because the ‘soft’ plastic material of the housing does not permit undistorted transmission to the sensor.

The object of the present invention is accordingly to specify an electrical device that enables a component that reacts to structure-borne noise and is arranged in the said electrical device to detect structure-borne noise signals propagating in a mounting surface without distortion and to pass the said signals on to an evaluation unit for evaluation.

This object is achieved by an electrical device having the features disclosed in claim 1. Advantageous embodiments are disclosed in the dependent claims.

The electrical device according to the invention, which is designed to be fastened on a mounting surface, is provided with a housing and with a support plate that is rigidly connected to the said housing by at least one connecting element. The support plate bears at least one electronic component that reacts to structure-borne noise, and this electronic component that reacts to structure-borne noise is arranged directly adjacent to one of the connecting elements.

The undistorted transmission of sound waves without losses, changes or attenuation can be provided in accordance with the idea of the invention by attaching the electronic component realized as a structure-borne noise sensor to the mounting surface as rigidly as possible. This is done by arranging the structure-borne noise sensor directly adjacent to a connecting element such that the structure-borne sound waves transmitted in the mounting surface are passed on directly to the structure-borne noise sensor by the housing and the connecting element.

It is particularly preferred to realize the housing in two parts from a housing jacket and a housing cover, as the electrical device can then be produced by an especially straightforward and affordable method.

An expedient embodiment of the invention provides for the support plate bearing the structure-borne noise sensor to be in direct contact with the connecting element. This ensures that the support plate is directly connected to the housing and, in particular, to the housing jacket. This in turn ensures that the support plate, and hence the structure-borne noise sensor, is rigidly connected to the mounting surface via the housing.

Another variant provides for the support plate to be fastened by a clamped connection between the housing jacket and the housing cover to transmit structure-borne sound waves generated in the mounting surface. The connecting element is not in direct contact with the support plate in this variant. An electrical device designed in this way has the advantage that it is reliable and straightforward to manufacture.

A realization in which the housing cover has a number of openings corresponding to the number of connecting elements and in which a bush is inserted into each of the said openings such that the clamping force acting on the support plate is applied through the bush and the housing jacket is particularly preferred. The bush in this arrangement is made from a rigid material, preferably a metal or ceramic, in order to ensure that the sound waves are transmitted directly.

It is preferable, for cost and manufacturing reasons, for the housing cover to be made from a plastic and for the bushes to be made from metal and to have housing cover material injection molded around their exterior. A form fit can be created by providing the bushes with a number of recesses or a continuous groove around their exterior circumference.

The housing jacket, which is connected directly to the mounting surface, is expediently made from a rigid material, particularly a metal. The use of a diecast aluminum housing jacket is especially preferred for this purpose.

It is further preferred for the bushes to protrude at least beyond the interior face, facing the interior of the housing, of the housing jacket. This ensures that the clamping force applied to the support plate is generated by the housing and the bush, each of which is made from rigid, hard materials. The essential sought-after rigidity of the connection of the structure-borne noise sensor to the mounting surface can be achieved by this means.

Using a plastic for the manufacture of the housing cover makes it straightforward to produce any required shape. The housing cover expediently has the shape of a plug-type connector element and is provided with at least one contact element extending from an exterior face to an interior face of the housing cover so as to permit an electrical and mechanical connection with an adaptor of corresponding design on the exterior face of the housing cover and with the support plate facing the interior face. What this means is that the housing cover performs the function of a plug-type connector as well as being a component of the housing. The provision of the contact element that passes through the housing cover makes it particularly straightforward to realize an electrical connection between the electrical device and a central control unit. The housing cover designed according to this variant, furthermore, makes it easy to establish electrical contact with the support plate via the contact elements designed into the housing cover, so two plug-type connectors are all that has to be provided to establish electrical contact with the structure-borne noise sensor on the support plate.

A further advantageous embodiment of the invention provides for a sealing compound to be applied to the exterior face of the housing cover once the housing jacket and the housing cover, which is connected to the support plate, have been joined in order to seal the interior of the housing against moisture.

It is intended according to the invention to provide the housing with at least one mounting flange, which mounting flange exhibits an opening, extending at right-angles to the mounting surface, to permit the passage of a further fastener to fasten the housing to the mounting surface.

Additional advantages, embodiments and expedient features of the electrical device according to the invention are explained in more detail below with reference to the drawing.

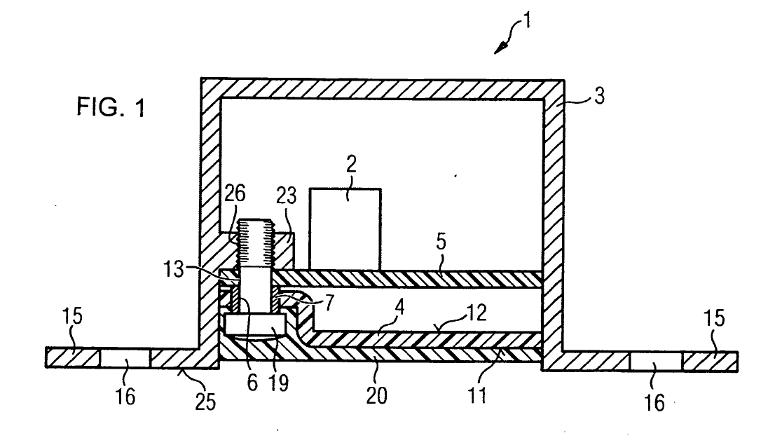

FIG. 1 shows an electrical device according to the invention in a cutaway view.

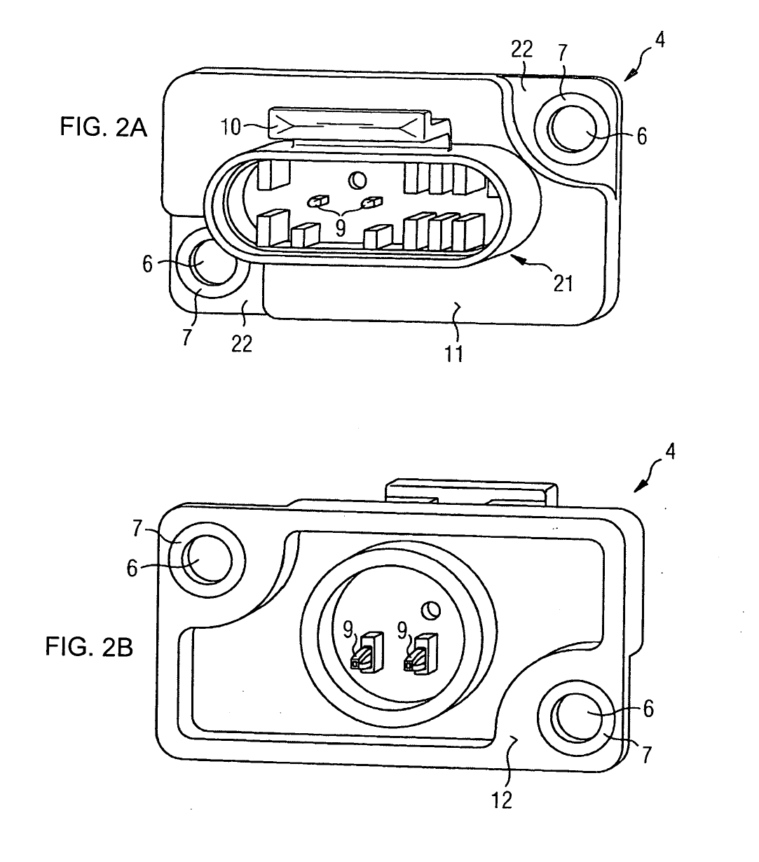

FIGS. 2a and 2b show the exterior face and interior face respectively of a housing cover of the electrical device according to the invention in a perspective view.

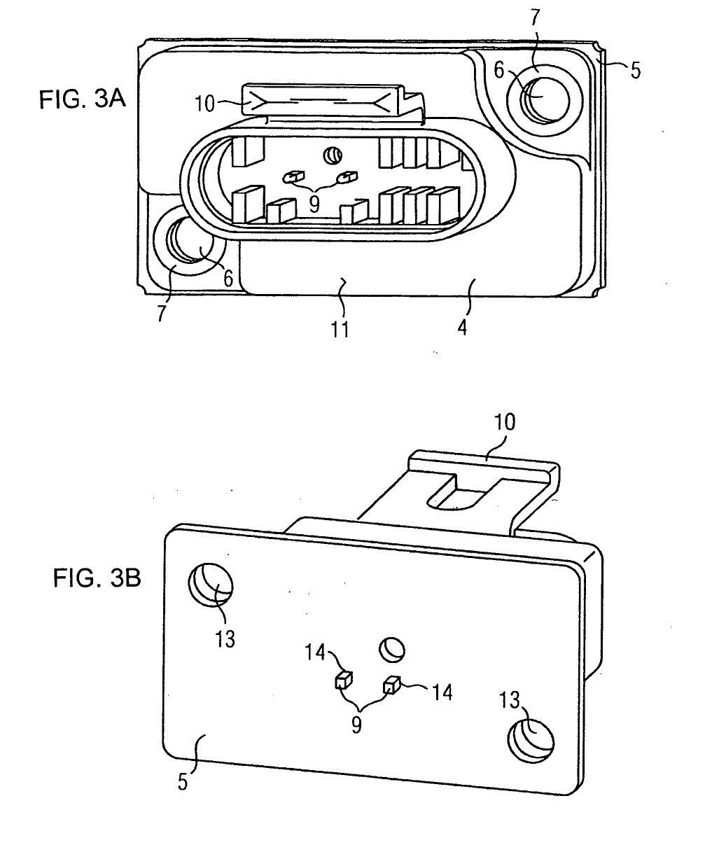

FIGS. 3a and b show the exterior face and interior face respectively of the housing cover in a perspective view with a support plate attached to the interior face.

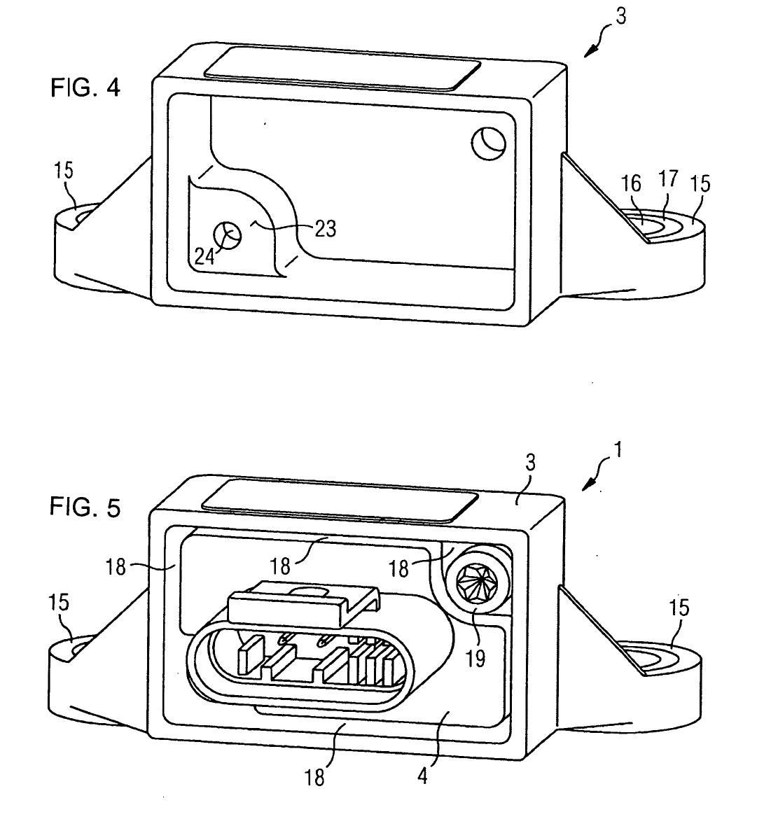

FIG. 4 shows a housing jacket of the electrical device in a perspective view.

FIG. 5 shows the electrical device according to the invention in a perspective view after the housing jacket and housing cover have been joined.

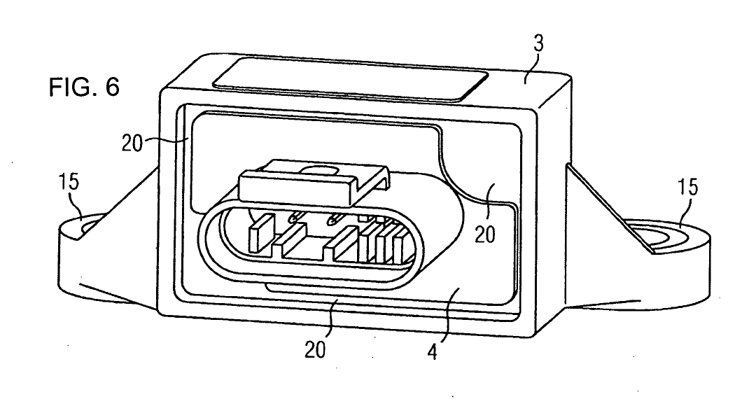

FIG. 6 shows the electrical device according to the invention in a perspective view with a sealing compound applied to the exterior face of the housing cover.

FIG. 1 shows the electrical device 1 according to the invention in a cutaway view. The electrical device 1 has a housing jacket 3 made from a rigid material, preferably a metal, and a housing cover 4 made from plastic. Merely for the purposes of description, the housing jacket 3 has, molded onto sides facing away from each other, mounting flanges 15, each of which exhibits an opening 16. The mounting flange forms the underside 25 of the electrical device 1 via which the electrical device is fastened to a mounting surface (not shown in the Figure) of a component. The openings 16 in the mounting flange are intended to receive fasteners. The fasteners, which are not shown in the figure, may, by way of example, be screw bolts that are welded to the mounting surface and extend at right angles and with parallel axes from the mounting surface of the component, for example a car body component of a motor vehicle. The openings 16 may be realized as metal bushes arranged in the mounting flanges, although the said bushes are not shown in FIG. 1.

The connection of the housing jacket 3 to the mounting surface of a component and the selection of the most rigid material possible for the housing jacket ensure that structure-borne sound waves propagating in the mounting surface are transmitted in almost completely undistorted form to the housing jacket 3 of the electrical device 1. A sensor 2 that detects the structure-borne sound waves is fastened on a support plate 5 arranged inside the housing and not directly to the housing jacket 3, so care must be taken to ensure that the sensor 2 and/or the support plate 5 is connected to the housing jacket 3 as rigidly as possible.

A suitably rigid connection is achieved according to the invention by clamping the support plate 5, which is made from an epoxy resin (FR4) or a ceramic, between a bearing surface 23 of the housing jacket 3 and the housing cover 4. The housing cover 4 has a metal bush 7 in an opening 6 to make sure that the connection between the support plate 5 and the housing jacket 3 is rigid. The said metal bush protrudes at least on the interior face 12 of the housing cover 4. It is preferable for the bush 7 also to protrude beyond the exterior face 11 of the housing cover as shown in the figure.

The support plate 5 likewise has an opening 13 in a corresponding position, as does the bearing surface 23. Screwing a fastener 19, realized as a self-tapping screw, into the openings 6, 13 and 26 ensures that the support plate 5 is pressed by the bush 7 against the bearing surface 23. The tension force of the screwed connection is thus transferred to the support plate 5 by the bush 7 alone. All of the materials involved in the screwed or clamped connection are made from a rigid, hard material, so the essential rigid connection of the structure-borne noise sensor 2 to the mounting surface is assured.

The electrical device shown in FIG. 1 is arranged, by way of example, on a car body component in the engine compartment. A sealing compound 20, which may be polyurethane or another suitable material, for example, is applied to the exterior face 11 of the housing cover in order to provide reliable protection against moisture penetrating into the interior of the housing.

The following FIGS. 2 to 6 show the components of the electrical device according to the invention in a perspective view with additional details.

FIGS. 2a and 2b show the exterior face 11 (FIG. 2a) and interior face 12 (FIG. 2b) respectively of a housing cover 4. It can be seen from FIG. 2a that the housing cover 4 has the function of a plug-type connector element in that a plug-type connector element 21 with a molded-on locating hook 10 is realized on its exterior face 11. The plug-type connector element 21 serves to fasten an adaptor of corresponding design mechanically and electrically. Two contact elements 9 that pass through the housing cover and can likewise be contacted on the interior face 12 (FIG. 2b) are shown by way of example on the inside of the plug-type connector element 21. The contact elements 9 serve among other purposes to establish electrical contact with the support plate 5, which can be seen more clearly in FIG. 3b. The support plate 5 itself is provided with printed conductors (not shown in the figure) that establish electrical contact with the sensor 2 (also not shown). It is of course also possible to arrange a multiplicity of other electrical components on the support plate 5. Not only do the contact elements 9 establish electrical contact with the support plate 5, but they also initially serve to ‘pre-position’ the support plate 5 against the housing cover 4 in that they are inserted through openings 14 in the support plate.

The housing cover 4 is fastened to the housing jacket 3 by means of two screws that can be guided through the openings 6 positioned diagonally opposite each other in the housing cover 4. The bushes 7 described in connection with FIG. 1 are arranged in the openings 6. The openings/bushes are in each case arranged here in recessed areas 22 of the exterior face such that the head of the screw does not stand proud of the surface defined by the exterior face 11 once the screwed connection with the housing jacket has been established (see also FIG. 5).

FIG. 4 shows a perspective view of a housing jacket 3 matched to the housing cover 4 shown in FIGS. 2 and 3. The housing jacket 3 has the mounting flange, already described in connection with FIG. 1, in which metal bushes 17 are arranged. Further fasteners can be inserted into the openings 16 thus created in order to fasten the housing jacket to a bearing surface 23 of a component. Also visible is a recess 24, created in the bearing surface 23, into which the screw is screwed.

FIG. 5 shows the electrical device according to the invention once the housing cover prepared according to FIG. 3 has been inserted into the housing jacket 3. Self-tapping screws 19 are used as the fasteners in each case in order to avoid any chips being formed in the interior of the housing jacket. The groove 18 appearing between the housing cover 4 and the housing jacket 3 is filled with a sealing compound such that the interior of the electrical device is protected against ingress of moisture and, in addition, a level surface is created.

1-10. (canceled)

11. A vibration sensor assembly, comprising:
a housing configured to be fastened on a mounting surface, said housing including:
a housing jacket formed of a rigid material and configured for fastening to the mounting surface; and
a housing cover formed of plastic material and configured as a plug connector;
a support plate fastened in said housing;
an electronic structure-borne noise sensor disposed on said support plate, configured to detect vibrations and to be contacted via said support plate;
said plug connector having at least one contact element extending from an exterior to an interior of said housing to facilitate an electrical and mechanical connection with an adapter of corresponding design on the exterior of said housing and with said support plate in the interior of said housing;
at least one connecting element rigidly connecting said support plate to said housing jacket under pressure, said electronic structure-borne noise sensor being disposed in an immediate vicinity of said at least one connecting element.

12. The sensor assembly according to claim 11, wherein said sensor is configured to detect structure-borne noise signals in a motor vehicle.

13. The sensor assembly according to claim 11, wherein said connecting element presses said support plate against said housing jacket substantially without another element inserted therebetween.

14. The sensor assembly according to claim 11, wherein said support plate is fastened by a clamped connection between said housing jacket and said housing cover for transmitting structure-borne sound waves generated in said mounting surface.

15. The sensor assembly according to claim 11, wherein said housing cover is formed with a number of openings equal to a number of connecting elements, and a bushing is inserted into each said openings and a clamping force acting on said support plate is effected by said bushings and said housing jacket.

16. The sensor assembly according to claim 15, wherein said bushings protrude beyond an interior face of said housing cover.

17. The sensor assembly according to claim 15, wherein said bushings are made from metal and have injection molding around an exterior thereof formed of a common material with said housing cover.

18. The sensor assembly according to claim 11, wherein said housing jacket is a metal housing jacket.

19. The sensor assembly according to claim 11, which comprises a sealing compound on an exterior of said housing cover for sealing an interior of said housing.

20. The sensor assembly according to claim 11, wherein said housing is formed with at least one mounting flange, and said mounting flange has an opening formed therein extending substantially perpendicular to the mounting surface and enabling a further fastener to pass therethrough for fastening said housing to the mounting surface.
